(19) United States
(12) Patent Application Publication
(10) Pub. No.: US 2026/0223018 A1
(43) Pub. Date: Jul. 30, 2026

(54) METHOD OF CONFIGURING AUTOMATIC GAIN CONTROLLERS OF A MULTI-ANTENNA TRANSMITTER AND RECEIVER ARRANGEMENT, COMPUTER PROGRAM PRODUCT, NON-TRANSITORY COMPUTER-READABLE STORAGE MEDIUM, MULTI-ANTENNA TRANSMITTER AND RECEIVER ARRANGEMENT, CONTROL UNIT, WIRELESS DEVICE, AND CHIPS THEREFOR

(71) Applicant: BEAMMWAVE AB, Lund (SE)

(72) Inventors: Joakim Axmon, Limhamn (SE); Bengt Lindoff, Bjärred (SE)

(21) Appl. No.: 19/159,013

(22) PCT Filed: Feb. 16, 2024
(86) PCT No.: PCT/SE2024/050157

§ 371 Date: Aug. 22, 2025

(30) Foreign Application Priority Data
Feb. 22, 2023 (SE) 2330098-1

(51) Int. Cl. H04W 52/52

(52) U.S. Cl. CPC H04W 52/52

(57) ABSTRACT

A method for a multi-antenna transmitter and receiver arrangement, MATARA, the MATARA comprising two or more antennas two or more transceiver front ends each comprising two or more transceivers, and two or more automatic gain controllers, AGCs, and wherein the MATARA is comprisable in a wireless device, WD, the method comprising: receiving a first plurality of radio signals comprising a first signal transmitted from a remote TNode; obtaining a signal power estimate for each of the first plurality of radio signals; obtaining information about correlation between characteristics of the radio signals received by the transceivers; grouping transceivers together in groups of transceivers in accordance with the obtained information; and configuring the AGCs in accordance with the obtained signal power estimates and in accordance with the groups of transceivers. Corresponding computer program product, multi-antenna transmitter and receiver arrangement, control unit, wireless device, and chips are also disclosed.

### TECHNICAL FIELD

The present disclosure relates to a method of configuring automatic gain controllers of a multi-antenna transmitter and receiver arrangement, computer program product, non-transitory computer-readable storage medium, multi-antenna transmitter and receiver arrangement, control unit, wireless device, and chip therefor.

More specifically, the disclosure relates to a method of configuring automatic gain controllers of a multi-antenna transmitter and receiver arrangement, computer program product, non-transitory computer-readable storage medium, multi-antenna transmitter and receiver arrangement, control unit, wireless device, and chip as defined in the introductory parts of the independent claims.

### BACKGROUND ART

In order to utilize the dynamics more fully in analog-to-digital converters (ADCs), there is a need for adapting the gain settings prior to the ADCs, e.g., by automatic gain controllers (AGCs).

The utilization of an AGC for a single transceiver is known. As an example, a first variable gain amplifier (VGA) setting is utilized when receiving an analog radio signal with the single transceiver, the received analog VGA-amplified radio signal is converted by an ADC, thereafter the signal power of the converted (digital) signal is estimated and information about the signal power is fed to an AGC, which adapts the VGA to better utilize the available ADC dynamics.

However, often the received radio signal does not have constant power. E.g., in orthogonal frequency-division multiplexing (OFDM) systems, often only a small portion of the total system bandwidth is allocated. This is not accounted for by the AGC. Thus, the AGC is unable to adapt the VGA to fully utilize the available ADC dynamics (which results in a lower signal-to-noise ratio, SNR).

Furthermore, applying AGC algorithms developed for single transceivers directly to a multi-transceiver arrangement, especially a multi-transceiver arrangement designed for millimeter Wave (mmW), also causes non-optimal AGC performance.

Thus, there is a need for improving the utilization of AGCs in multi-transceiver arrangements.

U.S. Pat. No. 7,551,907 B2 enables automatic gain control in ultra-wideband applications over multiple channels and frequency bands. However, there may be a need for improving the utilization of the AGCs disclosed in U.S. Pat. No. 7,551,907 B2.

### SUMMARY

An object of the present disclosure is to mitigate, alleviate or eliminate one or more of the above-identified deficiencies and disadvantages in the prior art and/or solve at least the above-mentioned problem or other problems.

According to a first aspect there is provided a method for a multi-antenna transmitter and receiver arrangement (MATARA), the MATARA comprising two or more antennas, two or more transceiver front ends each comprising two or more transceivers, and two or more automatic gain controllers (AGCs) and wherein the MATARA is comprisable in a wireless device (WD), the method comprising: receiving a first plurality of radio signals comprising a first signal transmitted from a remote transceiver node (TNode); obtaining a signal power estimate for each of the first plurality of radio signals; obtaining information about correlation between characteristics of the radio signals received by the transceivers; grouping transceivers together in groups of transceivers in accordance with the obtained information; and configuring the AGCs in accordance with the obtained signal power estimates and in accordance with the groups of transceivers.

According to some embodiments, each group of transceivers comprises a first transceiver connected to a vertically polarized antenna and a second transceiver connected to a horizontally polarized antenna, and each of the first and second transceivers is associated with one of the obtained signal power estimates, and each AGC is configured in accordance with the obtained signal power estimates associated with the first and second transceivers.

According to some embodiments, each group of transceivers comprises a first transceiver connected to a vertically polarized antenna and a second transceiver connected to a horizontally polarized antenna, and obtaining a signal power estimate for each of the first plurality of radio signals comprises obtaining a first signal power estimate for each of the first plurality of radio signals at a first time instant, and obtaining a second signal power estimate for each of the first plurality of radio signals at a second time instant, and the method further comprises: checking if the first and second signal power estimates associated with the first transceiver are substantially the same; checking if the first and second signal power estimates associated with the second transceiver are substantially the same; and configuring the AGCs comprises setting the AGCs having substantially the same first and second signal power estimates for both the first and second transceivers to be inverse proportional to the signal power estimates associated with the first transceiver and/or the second transceiver.

According to some embodiments, each group of transceivers comprises a transceiver for in-phase data and a transceiver for corresponding quadrature data, and a signal power estimate is obtained only for one of the transceiver for in-phase data and the transceiver for corresponding quadrature data and the AGC corresponding to the transceiver for in-phase data and the transceiver for corresponding quadrature data is configured in accordance with the obtained signal power estimate.

According to some embodiments, configuring the AGCs comprises: for each radio signal of the first plurality of radio signals having a signal power estimate lower than a signal power threshold, decreasing the gain of the AGC, such as decreasing the gain of the AGC significantly, or setting the gain of the AGC to zero.

According to some embodiments, the MATARA further comprises a baseband (BB) processor, and the method further comprises: obtaining, by the BB processor, resource block allocation information associated with the first signal from a subset of the first plurality of radio signals; and configuring the AGCs is performed in accordance with the obtained resource block allocation information.

According to some embodiments, the MATARA further comprises two or more variable gain amplifiers (VGAs), and two or more analog-to-digital converters (ADCs), and each VGA is connected to a respective ADC, and the method further comprises: amplifying, by the VGAs, the received first plurality of radio signals; and converting, by the ADCs, the (first plurality of) amplified radio signals into (a first plurality of) digital radio signals.

According to some embodiments, the MATARA further comprises a spatio-temporal filter (STEF), and the ADCs are connected to the STEF, and the STEF is connected to the BB processor and the method further comprises: reducing, by the STEF, the first plurality of digital radio signals to a second plurality of filtered digital radio signals, and the second plurality is smaller than the first plurality.

According to some embodiments, the MATARA further comprises a control unit, and the method further comprises configuring, by the control unit, the STEF in accordance with the configuring of the AGCs.

According to some embodiments, obtaining a signal power estimate for each of the first plurality of radio signals comprises obtaining a signal power estimate for each of the first plurality of radio signals at a first time instant, and obtaining a signal power estimate for each of the first plurality of radio signals at a second time instant, and obtaining resource block allocation information comprises obtaining resource block allocation information at a first time instant and at a second time instant, and the method further comprises: checking, for each of the first plurality of radio signals, if the signal power estimate at the second time instant is substantially the same as the signal power estimate at the first time instant; for each of the first plurality of radio signals having the signal power estimate at the second time instant substantially the same as the signal power estimate at the first time instant, checking the resource block allocation information to find out if the number of resource blocks allocated at the first time instant is larger than the number of resource blocks allocated at a second time instant; and for each of the first plurality of radio signals having the signal power estimate at the second time instant substantially the same as the signal power estimate at the first time instant and the number of resource blocks allocated at the first time instant larger than the number of resource blocks allocated at a second time instant, setting the gain of the corresponding AGC to a first gain for the first time instant and to a second gain for the second time instant, and the second gain is smaller than the first gain.

According to some embodiments, obtaining a signal power estimate comprises estimating the signal power estimate in accordance with: an actual signal power estimate, such as a received signal strength indicator, RSSI; a sum of absolute values, such as a sum of absolute values of in-phase data and quadrature data; a number of saturated ADC samples and optionally a look up table; or a number of non-saturated ADC samples and optionally a look up table.

According to a second aspect there is provided a program product comprising instructions, which, when executed on at least one processor of a processing device, cause the processing device to carry out the method according to the first aspect or any of the embodiments mentioned herein.

According to a third aspect there is provided a non-transitory computer-readable storage medium storing one or more programs configured to be executed by one or more processors of a processing device, the one or more programs comprising instructions which, when executed by the processing device, causes the processing device to carry out the method according to the first aspect or any of the embodiments mentioned herein.

According to a fourth aspect there is provided a computer program product comprising a non-transitory computer readable medium, having stored thereon a computer program comprising program instructions, the computer program being loadable into a data processing unit and configured to cause execution of the method of the first aspect or any of the above-mentioned embodiments when the computer program is run by the data processing unit.

According to a fifth aspect there is provided a multi-antenna transmitter and receiver arrangement (MATARA), the MATARA comprising two or more antennas, two or more transceivers, and two or more automatic gain controllers (AGCs) and the MATARA is comprisable in a wireless device (WD), and the MATARA is configured to: receive a first plurality of radio signals comprising a first signal transmitted from a remote TNode; obtain a signal power estimate for each of the first plurality of radio signals; obtain information about correlation between characteristics of the radio signals received by the transceivers; group transceivers together in groups of transceivers in accordance with the obtained information; and configure the AGCs in accordance with the obtained signal power estimates and in accordance with the groups of transceivers.

According to a sixth aspect there is provided a control unit for a multi-antenna transmitter and receiver arrangement (MATARA), the MATARA comprising two or more antennas, two or more transceivers, and two or more automatic gain controllers (AGCs) and the MATARA is comprisable in a wireless device (WD), and the control unit configured to cause: reception of a first plurality of radio signals comprising a first signal transmitted from a remote TNode; obtainment of a signal power estimate for each of the first plurality of radio signals; obtainment of information about correlation between characteristics of the radio signals received by the transceivers; grouping of transceivers together in groups of transceivers in accordance with the obtained information; and configuration of the AGCs in accordance with the obtained signal power estimates and in accordance with the groups of transceivers.

According to a seventh aspect there is provided a wireless device (WD). The WD comprises the MATARA of the third aspect.

According to an eighth aspect there is provided a chip comprising the control unit of the fourth aspect.

Effects and features of the second, third, fourth, fifth, sixth, seventh, and eighth aspects are fully or to a large extent analogous to those described above in connection with the first aspect and vice versa. Embodiments mentioned in relation to the first aspect are fully or largely compatible with the second, third, fourth, fifth, sixth, seventh, and eighth aspects and vice versa.

An advantage of some embodiments is that power consumption is reduced or optimized (for the wireless device).

Another advantage of some embodiments is that an improved/optimized AGC/ADC performance is achieved, e.g., by grouping according to correlated characteristics.

A further advantage of some embodiments is that a more robust solution/system is achieved, e.g., by utilizing resource allocation information for the AGC.

Yet a further advantage of some embodiments is that available ADC dynamics is more fully utilized.

Yet a further advantage of some embodiments is that an improved/optimized AGC/ADC performance is achieved and/or that more flexibility in the fine tuning of receiver/transceiver chain/AGC/ADC performance is achieved, e.g., by the AGC/AGCs adapting the spatio-temporal filter (STEF) or the filter coefficients thereof. In some embodiments the grouping of a horizontally polarized antenna together with a vertically polarized antenna is especially advantageous for mmW transceiver architectures, wherein the antennas are patch antennas, and MIMO transmission is based on transmitting different layers on different polarizations.

Yet another further advantage of some embodiments is that low complexity (e.g., of power estimation) is achieved, thereby reducing power consumption.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Moreover, the term “configured” or “adapted” is intended to mean that a unit or similar is shaped, sized, connected, connectable or otherwise adjusted for a purpose.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1A is a flowchart illustrating method steps according to some embodiments;

FIG. 1B is a flowchart illustrating some method steps according to some embodiments;

FIG. 1C is a flowchart illustrating some method steps according to some embodiments;

FIG. 1D is a flowchart illustrating some method steps according to some embodiments;

FIG. 2 is a schematic drawing illustrating a computer readable medium according to some embodiments;

FIG. 3A is a flowchart illustrating actions/method steps implemented in a multi-antenna transmitter and receiver arrangement (MATARA) according to some embodiments;

FIG. 3B is a flowchart illustrating some actions/method steps implemented in a multi-antenna transmitter and receiver arrangement (MATARA) according to some embodiments;

FIG. 3C is a flowchart illustrating some actions/method steps implemented in a multi-antenna transmitter and receiver arrangement (MATARA) according to some embodiments;

FIG. 3D is a flowchart illustrating some actions/method steps implemented in a multi-antenna transmitter and receiver arrangement (MATARA) according to some embodiments;

FIG. 4A is a flowchart illustrating actions/method steps caused by control unit for a multi-antenna transmitter and receiver arrangement (MATARA) according to some embodiments;

FIG. 4B is a flowchart illustrating some actions/method steps caused by control unit for a multi-antenna transmitter and receiver arrangement (MATARA) according to some embodiments;

FIG. 4C is a flowchart illustrating some actions/method steps caused by control unit for a multi-antenna transmitter and receiver arrangement (MATARA) according to some embodiments;

FIG. 4D is a flowchart illustrating some actions/method steps caused by control unit for a multi-antenna transmitter and receiver arrangement (MATARA) according to some embodiments; and

FIG. 5 is a schematic drawing illustrating a wireless device according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a processor/processing unit. The processor may be a digital processor. Alternatively, the processor may be a microprocessor, a microcontroller, a central processing unit, a co-processor, a graphics processing unit (GPU), a digital signal processor (DSP), an image signal processor, a quantum processing unit, or an analog signal processor.

The processing unit may comprise one or more processors and optionally other units, such as a control unit. Thus, the processor may be implemented as a single-processor, a dual-processor system, or a multiprocessor system. Furthermore, the invention can also be practiced in distributed computing environments where certain tasks are performed by remote processing devices that are linked through a communications network, e.g., 5G, to one or more local processors. In a distributed computing environment, program modules can be located in both local and remote memory storage devices. Moreover, some processing (e.g., for the data plane) may be moved to a centralized node, such as a centralized transceiver node (TNode). For example, baseband processing and/or higher layer processing, such as processing at layers above the physical layer, may be moved to a cloud, such as an mmW RAN cloud (wherein processing is performed by cloud processors). Such a (mmW) cloud deployment may bring significant cost savings to the operator due to centralized processing, collaborative radio processing, and availability of cheap commodity hardware.

Below is referred to a baseband (BB) processor/processing unit. A BB processor is a processor specifically adapted for processing baseband signals/data.

Below is referred to a control unit. A control unit may be a processor or a processing unit.

Below is referred to a spatio-temporal filter (STEF). A spatio-temporal filter processes or is configured to process analog or digital data/signals in one or more of a spatial domain and a time domain to obtain digital signals.

Herein is referred to millimetre Wave (mmW) utilization, mmW communication, mmW communication capability and mmW frequency range. The mmW frequency range is from 24.25 Gigahertz (GHz) to 71 GHz or more generally from 24 to 300 GHz. The mmW frequency range may also be referred to as Frequency Range 2 (FR2).

Below is referred to a chip. A chip is an integrated circuit (chip) or a monolithic integrated circuit (chip) and may also be referred to as an IC, or a microchip.

Below is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V2I) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, and tablets.

Below is referred to a “transceiver node” (TNode). A TNode may be a radio unit (RRU), a repeater, a wireless node, or a base station (BS), such as a radio base station (RBS), a Node B, an Evolved Node B (eNB) or a gNodeB (gNB). Thus, a TNode may be a NW node. Furthermore, a TNode may be a BS for a neighbouring cell, a BS for a handover (HO) candidate cell, a radio unit (RRU), a distributed unit (DU), another WD (e.g., a remote WD) or a base station (BS) for a (active/deactivated) secondary cell (SCell) or for a serving/primary cell (PCell, e.g., associated with an active TCI state), a laptop, a wireless station, a relay, a repeater device, a reconfigurable intelligent surface, or a large intelligent surface.

The polarization of an antenna refers to the orientation of the electric field of the radio wave transmitted by it and is determined by the physical structure of the antenna and its orientation. E.g., an antenna composed of a linear conductor (such as a dipole or whip antenna) oriented vertically will result in vertical polarization; if turned on its side the same antenna's polarization will be horizontal.

Basic concept A basic concept of this invention is to group transceivers together in groups of transceivers based on correlation between characteristics, such as radio (channel) characteristics, of the radio signals received by the transceivers (or based on correlation between characteristics of the transceivers), and configuring the AGCs in accordance with obtained signal power estimates and in accordance with the groups of transceivers.

### Embodiments

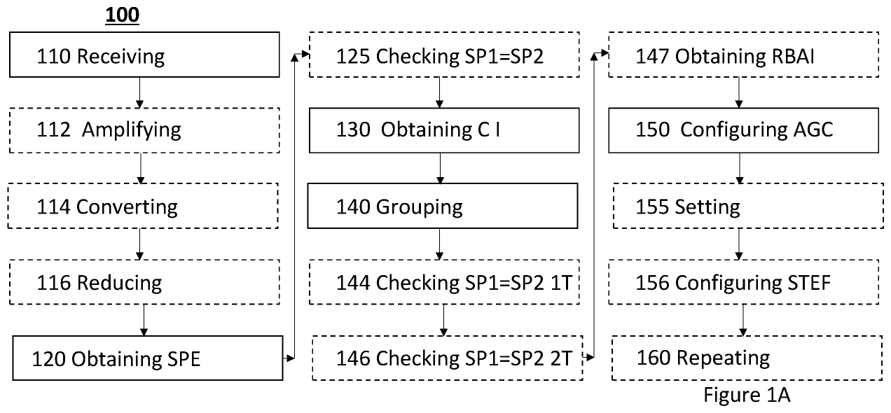

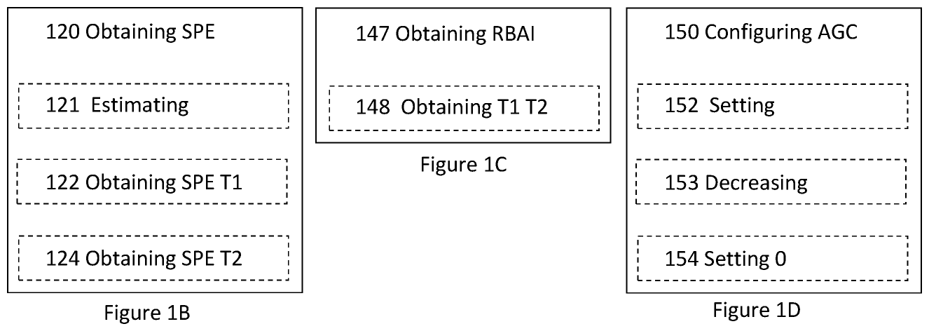

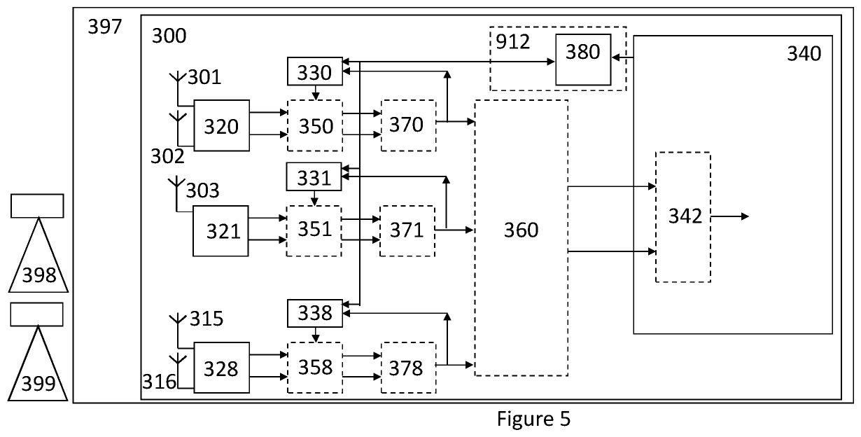

In the following, embodiments will be described where FIG. 1A-1D illustrates method steps according to some embodiments. The method 100 is for a multi-antenna transmitter and receiver arrangement (MATARA) 300. The MATARA 300 comprises two or more antennas 301, 302, . . . , 316 (shown in FIG. 5). Alternatively, the MATARA 300 comprises three or more antennas 301, 302, . . . , 316. As another alternative, the MATARA 300 comprises four or more antennas 301, 302, . . . , 316. Furthermore, the MATARA 300 comprises one or two or more transceiver front ends 320, 321, . . . , 328 (shown in FIG. 5). Each transceiver front end 320, 321, . . . , 328 comprises one or two or more transceivers. Moreover, the MATARA 300 comprises two or more automatic gain controllers (AGCs) 330, 331, . . . , 338. In some embodiments, the MATARA 300 comprises a baseband (BB) processor 340. Furthermore, in some embodiments, the MATARA 300 comprises two or more variable gain amplifiers (VGAs) 350, 351, . . . , 358. Moreover, in some embodiments, the MATARA 300 comprises two or more analog-to-digital converters (ADCs) 370, 371, . . . , 378. Each VGA 350, 351, . . . , 358 is connected/connectable to a respective ADC 370, 371, . . . , 378. In some embodiments, the MATARA 300 comprises a spatio-temporal filter (STEF) 360. In these embodiments, the ADCs 370, 371, . . . , 378 are connected/connectable to the STEF 360, and the STEF 360 is connected/connectable to the BB processor 340. Furthermore, in some embodiments, the MATARA 300 comprises a control unit 380. The MATARA 300 is comprisable or comprised in a wireless device (WD) 397. The method 100 comprises receiving 110, e.g., by the two or more antennas 301, 302, . . . , 316 and/or the one or two or more transceiver front ends 320, 321, . . . , 328 (e.g., by two or more transceiver chains, each transceiver chain comprising at least one antenna and at least one transceiver), a first plurality of radio signals (each or together) comprising a first signal transmitted from a remote TNode 398, 399. In some embodiments, the first signal is an orthogonal frequency-division multiplexing (OFDM) signal. Moreover, in some embodiments, the OFDM signal has a certain frequency allocation, such as a number of resource blocks. The resource allocation can be either contiguous or non-contiguous.

Furthermore, the method 100 comprises obtaining 120, e.g., by the AGCs 330, 331, . . . , 338, a signal power estimate for each (or for a subset) of the first plurality of radio signals. In some embodiments, each of the AGCs 330, 331, . . . , 338 comprises a signal power estimation unit.

Each of the signal power estimation units are configured to estimate the signal power of the respective radio signal. Furthermore, in some embodiments, each of the AGCs 330, 331, . . . , 338 comprises a computation unit. Each of the computation units are configured to compute gain adjustments or gain settings. Alternatively, or additionally, gain adjustments or gain settings are computed by the control unit 380. In some embodiments, obtaining 120 a signal power estimate comprises estimating 121, e.g., by the signal power estimation unit, the signal power in accordance with an actual signal power, such as a received signal strength indicator (RSSI), a received signal strength measurement, an amplitude, or a signal interference noise power estimate. Alternatively, obtaining 120 a signal power estimate comprises estimating 121 the signal power in accordance with a sum of absolute values, such as a sum of absolute values of in-phase data and quadrature data or a sum of absolute values of imaginary data and real data. As another alternative, obtaining 120 a signal power estimate comprises estimating 121 the signal power in accordance with a number of saturated ADC samples (i.e., a number of ADC samples above a threshold) and optionally a look up table (comprising the signal power in the slot having the number equal to the number of ADC samples above the threshold). As yet another alternative, obtaining 120 a signal power estimate comprises estimating 121 the signal power in accordance with a number of non-saturated ADC samples (i.e., a number of ADC samples below a threshold) and optionally a look up table (comprising the signal power in the slot having the number equal to the number of ADC samples below the threshold). The received signal has certain statistical properties, e.g., an OFDM signal has a circularly symmetric complex normal distribution. Hence, (at least for OFDM signals) the in-phase data and the quadrature data can be assumed to have normal distribution. Thus, an optimal clipping can be determined, e.g., as 6 bits clipping at 3.33 sigma/standard deviations and 8 bits clipping at approx. 4 sigma/standard deviations (and the power is proportional to sigma to the power of 2, i.e., the power is proportional to sigma*sigma). The number of clipped/saturated samples (or the number of samples above/below a certain ADC level/threshold) can thus be computed/calculated. From the computed/calculated number of clipped/saturated samples, the sigma/standard deviation as well as the power can be obtained. Moreover, the method 100 comprises obtaining 130, e.g., by the control unit 380, information about correlation (or correlation information) between/of characteristics, such as radio (channel) characteristics, of the radio signals (i.e., the first plurality of radio signals) received by the transceivers (or of the transceivers associated with each of the first plurality of radio signals). In some embodiments, the control unit 380 obtains the information about correlation between/of characteristics of the radio signals by comparing signal power estimates (SPEs) from different AGCs. As an example, if the SPE of one or more of the AGCs is lower than a signal power threshold, whereas all other SPEs are higher than the signal power threshold, the radio signals or the transceivers associated with an SPE which is lower than a signal power threshold are correlated (and is thus grouped together), whereas the radio signals or the transceivers associated with an SPE which is higher than the signal power threshold are correlated (and may thus be grouped together). Furthermore, the radio signals or the transceivers associated with an SPE which is lower than a signal power threshold may be said to be less or not correlated (or uncorrelated, e.g., if their covariance is zero) with the radio signals or the transceivers associated with an SPE which is higher than the signal power threshold and vice versa. Moreover, the method 100 comprises, e.g., by the control unit 380, grouping 140 transceivers together in groups of transceivers in accordance with the obtained information (i.e., the information about correlation between characteristics of the radio signals received by the different transceivers). In some embodiments, the number of groups of transceivers is smaller than the first plurality.

The method 100 comprises configuring 150, e.g., by the control unit 380, the AGCs in accordance with the obtained signal power estimates and in accordance with the groups of transceivers (or in accordance with the grouping 140).

In some embodiments, each group or at least one group of transceivers comprises a first transceiver connected to a vertically polarized antenna and a second transceiver connected to a (corresponding) horizontally polarized antenna, i.e., the grouping 140 is performed so that a second transceiver connected to a horizontally polarized antenna is grouped together with a first transceiver connected to a (corresponding) vertically polarized antenna. Each of the first and second transceivers is associated with one of the obtained signal power estimates. Furthermore, each AGC 330, 331, . . . , 338 is configured in accordance with the obtained signal power estimates associated with the first and second transceivers.

Alternatively, each AGC 330, 331, . . . , 338 is configured in accordance with a joint/median/mean signal power estimate derived from the obtained signal power estimates associated with the first and second transceivers. Thus, the AGC (and the VGA) settings applied to signals received by a first and a second transceiver of the same group are the same (or equal), e.g., the AGC settings are set in accordance with the maximum of the signal power estimate associated with the vertically polarized antenna and the signal power estimate associated with the horizontally polarized antenna. Applying the same AGC settings (and VGA settings) to signals received by a first transceiver (connected to a vertically polarized antenna) and a second transceiver (connected to a corresponding horizontally polarized antenna) may be advantageous, since a higher degree of robustness is achieved, especially for a WD, which can be rotated quickly. Depending on XYZ-direction of the antennas of the WD 397 the signal power for the vertically polarized antenna and the horizontally polarized antenna may vary quickly, but the signal power for the vertically polarized antenna and the horizontally polarized antenna should on average be equal.

In some embodiments, each group of transceivers comprises a transceiver for in-phase data and a transceiver for corresponding quadrature data, i.e., the grouping 140 is performed so that a transceiver for in-phase data is grouped together with a transceiver for corresponding quadrature data (or grouping 140 is performed so that each group of transceivers comprises a transceiver for in-phase data and a transceiver for corresponding quadrature data. Furthermore, a signal power estimate is obtained only for one of the transceiver for in-phase data and the transceiver for corresponding quadrature data (or for the received signals associated therewith). Thus, the estimation procedure is made less power/time consuming and/or less complex. Moreover, the AGC corresponding to the transceiver for in-phase data and the transceiver for corresponding quadrature data is configured in accordance with the obtained signal power estimate (for the transceiver for in-phase data or for the transceiver for corresponding quadrature data), e.g., the AGC settings (and the VGA settings) for in-phase data and quadrature data are the same. Thus, the gain for the transceiver for in-phase data (i.e., for the I chain/branch) and the gain for the transceiver for corresponding quadrature data (i.e., for the corresponding Q chain/branch) are equal (the same). The gain for the transceiver for in-phase data and the gain for the transceiver for corresponding quadrature data may be set equal, e.g., since the received signal is (at least for OFDM signals) circularly symmetric (i.e., having the same variance for in-phase data and quadrature data). Any IQ imbalance may destroy the circular symmetry but may be calibrated prior to operation of the transceiver. Thus, in some embodiments, any IQ imbalance is handled elsewhere, i.e., is not considered to be part of the AGC. Thus, “equal for I and Q chains/branches” means equal for I and Q chains/branches on top of potential compensation for IQ imbalance (which in itself may contribute with different gain factors for I and Q).

In some embodiments, each group of transceivers comprises a first transceiver connected to a vertically polarized antenna and a second transceiver connected to a horizontally polarized antenna, i.e., the grouping 140 is performed so that a second transceiver connected to a horizontally polarized antenna is grouped together with a first transceiver connected to a vertically polarized antenna. Furthermore, obtaining 120 a signal power estimate for each of the first plurality of radio signals comprises obtaining 122 a first signal power estimate for each of the first plurality of radio signals at a first time instant, and obtaining 124 a second signal power estimate for each of the first plurality of radio signals at a second time instant (occurring after the first time instant). Moreover, the method comprises checking 144 if the first and second signal power estimates associated with the first transceiver are substantially the same (i.e., if the difference between the first and second signal power estimates is below a threshold amount, such as 5%, 10%, 15% or 20%). The method comprises checking 146 if the first and second signal power estimates associated with the second transceiver are substantially the same (i.e., the difference between the first and second signal power estimates is below a threshold amount, such as 0.1). If an AGC has substantially the same first and second signal power estimates for both the first and second transceivers, it is considered/determined that the WD 397 comprising the first and second transceivers is stationary (i.e., not moving). Furthermore, configuring 150 the AGCs comprises setting 152 the AGCs having substantially the same first and second signal power estimates for both the first and second transceivers (upon determining that at least one AGC has substantially the same first and second signal power estimates for both the first and second transceivers, i.e., upon determining that the WD 397 is stationary) to be inverse proportional to the signal power estimates associated with the first transceiver and/or the second transceiver (and if no such AGCs exist, leaving the AGC settings as is). As an alternative, determining that the WD 397 is stationary may instead be in accordance with capability information for the WD 397, i.e., the capability information may indirectly or directly state that the WD 397 is stationary. Setting the AGCs having substantially the same first and second signal power estimates for both the first and second transceivers to be inverse proportional to the signal power estimates associated with the first transceiver and/or the second transceiver may be advantageous, especially for Fixed Wireless Access (FWA), reconfigurable intelligent surface, or a large intelligent surface (e.g., over mmW), since if the WD 397 is stationary, the probability of rotational movement of the WD 397 is small or zero, and thus the gain for the first and second transceivers can be assumed to be constant. Thus, in some embodiments, the WD 397 is an FWA point. Alternatively, in some embodiments, the WD 397 is the backhaul link of an integrated access and backhaul (IAB) link, a reconfigurable intelligent surface, or a large intelligence surface.

In some embodiments, configuring 150 the AGCs comprises, for each radio signal of the first plurality of radio signals having a signal power estimate lower than a signal power threshold or for each radio signal of the first plurality of radio signals having a signal power estimate lower than a median/mean power estimate of all of the first plurality of radio signals, decreasing 153 the gain of the AGC. In some embodiments, decreasing 153 the gain of the AGC comprises decreasing the gain of the AGC significantly, e.g., decreasing the gain of the AGC to half the value (or lower) or to a quarter of the value or lower (decreasing the gain of the AGC with 50/25 percent or more). Alternatively, decreasing 153 the gain of the AGC comprises setting 154 the gain of the AGC to zero. As an example, if a radio signal of the first plurality of radio signals having a signal power estimate lower than a signal power threshold (or lower than a median/mean power estimate of all of the first plurality of radio signals), it may be considered/determined that the antenna receiving the radio signal is blocked, e.g., by an obstacle, such as a user's hand or finger or fingernail.

Alternatively, or additionally, obtaining 130 comprises comparing 132 the signal power estimate for each of the first plurality of radio signals to a signal power estimate (SPE) threshold. Furthermore, grouping 140 comprises placing 142 all transceivers having a signal power estimate lower than the SPE threshold in a first group and optionally placing all other transceivers in a second group. Moreover, configuring 150 comprises decreasing 153 the gain of the AGC, such as decreasing the gain of the AGC significantly, or setting 154 the gain of the AGC to zero, for all radio signal of the first plurality of radio signals associated with a transceiver placed in the first group. Thus, the power consumption may be decreased, e.g., as signals from blocked transceivers are not further processed. Alternatively, the STEF 360 may decrease (or may be configured by the control unit 380 to decrease) the coefficients associated with the transceivers in the first group and/or increase the coefficients associated with the transceivers in the second group.

In some embodiments, the MATARA 300 comprises a baseband (BB) processor 340.

Alternatively, the WD 397 comprises the BB processor 340 and the MATARA 300 and the MATARA 300 is connected or connectable to the BB processor 340. Furthermore, the method comprises obtaining 147 resource block allocation information from a subset of the first plurality of radio signals. Obtaining 147 is performed by the BB processor 340 (e.g., if the BB processor 340 comprises the control unit 380. Alternatively, obtaining 147 is performed by the control unit 380, i.e., the control unit 380 obtains resource block allocation information from the BB processor 340, e.g., if the control unit 380 is external to and connected/connectable to the BB processor 340. The resource block allocation information is associated with the first signal, e.g., the resource block allocation information comprises information about resource block allocation for the first signal. Moreover, the method comprises performing configuring 150 the AGCs in accordance with the resource block allocation information. In some embodiments, the resource allocation information is obtained by the BB processor 340 from a third plurality of (radio) signals associated with the first signal (e.g., a subset of the first plurality of radio signals). The third plurality is smaller than or equal to the first plurality (i.e., the number of the third plurality of radio signals is lower than or equal to the number of the first plurality of radio signals). The third plurality of signals (i.e., the subset) may be/comprise all (of the first plurality of) signals, only signals from antennas that are not blocked (e.g., only signals that have a measured received energy higher than a threshold; and hence not signals that have a measured received energy lower than or equal to the threshold), only signals from antennas located on one side of the WD 397 (and not signals from antennas located on the opposite side of the WD 397), only signals from vertically polarized antennas (and hence not signals from horizontally polarized antennas), or only signals from horizontally polarized antennas (and hence not signals from vertically polarized antennas). In these embodiments, configuring 150 the AGCs is performed in accordance with the obtained resource block allocation information. In some embodiments, obtaining 147 resource block allocation information comprises measuring received energy (of the first signal, of the third plurality of signals, or of the first plurality of radio signals) and convert the measured received energy to a spectral density by checking a load of a cell or checking how large a portion of the cell has been allocated (i.e., the load portion of the whole cell width/bandwidth/bandwidth part/frequency range) and thereafter compare the measuring received energy to the load/portion. The (estimated) spectral density is then utilized (as resource block allocation information) when configuring 150 the AGCs.

In some embodiments, the resource block allocation information comprises information about resource allocation in terms of a total number of allocated (“non-zero power”) resource blocks (i.e., the allocated bandwidth) in relation to the configured receiver/transceiver/WD bandwidth (e.g., a ratio between the total number of allocated resource blocks and the configured receiver/transceiver/WD bandwidth. Alternatively, the resource block allocation information comprises information about a ratio between a total number of allocated resource blocks and a total number of resource blocks comprisable in the bandwidth/bandwidth part configured for the transceiver/WD. In these embodiments, configuring 150 the AGCs is performed in accordance with the ratio.

In some embodiments, the MATARA 300 comprises two or more variable gain amplifiers (VGAs) 350, 351, . . . , 358, and two or more analog-to-digital converters (ADCs) 370, 371, . . . , 378. Furthermore, each VGA is connected to a respective ADC (as indicated in FIG. 5). Moreover, the method comprises amplifying 112, by the VGAs, the received first plurality of radio signals. The method comprises converting 114, by the ADCs, the (first plurality of) amplified radio signals into (a first plurality of) digital (amplified) radio signals.

In some embodiments, the MATARA 300 comprises one or more spatio-temporal filters (STEFs) 360. The ADCs 370, 371, . . . , 378 are connected/connectable to the STEFs 360. Furthermore, the STEFs 360 are connected/connectable to the BB processor 340. Moreover, the method comprises reducing 116, by the STEFs 360, the first plurality of digital radio signals to a second plurality of filtered digital (amplified) radio signals. In some embodiments, the second plurality is smaller than the first plurality (i.e., the number of the second plurality of filtered digital radio signals is lower than the number of the first plurality of digital radio signals). Thereby, reduced power consumption and/or lower complexity is achieved. In some embodiments, the STEFs 360 are one or more prefilters, e.g., spatio-temporal prefilters, and/or one or more combining/adding filters (combining or adding the first plurality of digital radio signals together to form a second plurality of filtered digital radio signals). In some embodiments, the STEFs 360 are 2D filters and the processing (by the STEFs 360) is performed in time and/or space domain.

In some embodiments, the MATARA 300 comprises a control unit 380. The method 100 comprises configuring 156, by the control unit 380, the STEF or STEFs 360 (or filter coefficients thereof) in accordance with the configuring 150 of the AGCs. By taking into account the configuring of the AGCs when configuring the STEF/STEFs 360, fine-tuning the AGC settings by adjusting settings of the one or more STEFs 360 is enabled/achieved. Thus, in some embodiments, the amplification (by the VGAs and AGCs) is fine-tuned by adjusting settings, such as gain (i.e., a scaling is performed) and/or phase (i.e., a phase adjustment is performed), of the one or more STEFs 360, thereby avoiding or by-passing limitations of the resolution of the ADCs 370, 371, . . . , 378. As an example, first an AGC setting is calculated (by the AGC; for each of the AGCs) and then a first (substantial) portion of the calculated AGC setting/gain is applied to the corresponding VGA by the AGC and thereafter a second (small or smaller) portion (i.e., the remainder) is applied by/to the one or more STEFs 360 (or by/to the corresponding STEF). In some embodiments, the first (substantial) portion of the calculated AGC setting/gain is in accordance with the resolution of the ADC.

In some embodiments, the method 100 comprises repeating the steps 110, 120, 130, 140, 150 and optionally one or more of the steps of 112, 114, 116, 125, 144, 146, 147, 155, 156, 121, 122, 124, 148, 152, 153, 154 and any other steps described herein.

In some embodiments, obtaining 120 a signal power estimate for each of the first plurality of radio signals comprises obtaining 122 a signal power estimate for each of the first plurality of radio signals at a first time instant, and obtaining 124 a signal power estimate for each of the first plurality of radio signals at a second time instant (the second time instant occurring after the first time instant). Furthermore, in these or other embodiments, obtaining 147 resource block allocation information comprises obtaining 148 resource block allocation information (associated with the first signal) at a first time instant and at a second time instant. Moreover, in these or other embodiments, the method 100 (further) comprises checking 125, for each of the first plurality of radio signals, if the signal power estimate at the second time instant is substantially the same as the signal power estimate at the first time instant (i.e., if the difference between the first and second signal power estimates is below a threshold amount, such as 0.1 or 0.01). The method 100 comprises, (e.g., only) for each (if any) of the first plurality of radio signals having the signal power estimate at the second time instant substantially the same as the signal power estimate at the first time instant, checking (or comparing) 149 the resource block allocation information (at the first and second time instant) to find out if the number of resource blocks allocated at the first time instant is larger than the number of resource blocks allocated at a second time instant. Furthermore, the method 100 comprises, (e.g., only) for each (if any) of the first plurality of radio signals having the signal power estimate at the second time instant substantially the same as the signal power estimate at the first time instant and the number of resource blocks allocated at the first time instant larger than the number of resource blocks allocated at a second time instant, setting 155 the gain of the corresponding AGC to a first gain for the first time instant (or for a first time period associated with the first time instant, e.g., occurring just after the first time instant) and to a second gain for the second time instant (or for a second time period associated with the second time instant, e.g., occurring just after the second time instant). In some embodiments, the second gain is smaller than the first gain. By setting the second gain smaller than the first gain, excessive clipping may be avoided or clipping may be reduced (e.g., if the power is larger at the second time instant than at the first time instant).

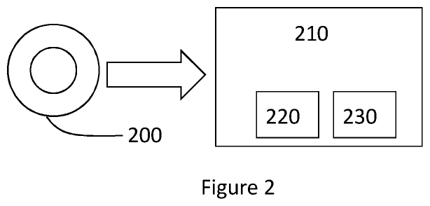

According to some embodiments, a computer program product comprising a non-transitory computer readable medium 200, such as a punch card, a compact disc (CD) ROM, a read only memory (ROM), a digital versatile disc (DVD), an embedded drive, a plug-in card, or a universal serial bus (USB) memory, is provided. FIG. 2 illustrates an example computer readable medium in the form of a compact disc (CD) ROM 200. The computer readable medium has stored thereon, a computer program comprising program instructions. The computer program is loadable into a data processor (PROC) 220, which may, for example, be comprised in a computer 210 or a computing device or the processing unit 600. When loaded into the data processor 220, the computer program may be stored in a memory (MEM) 230 associated with or comprised in the data processor 220. According to some embodiments, the computer program may, when loaded into and run by the data processor 220, cause execution of method steps according to, for example, the method illustrated in FIGS. 1A-1D, which is described herein. Furthermore, in some embodiments, there is provided a computer program product comprising instructions, which, when executed on at least one processor of a processing device, cause the processing device to carry out the method illustrated in FIGS. 1A-1D. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIGS. 1A-1D.

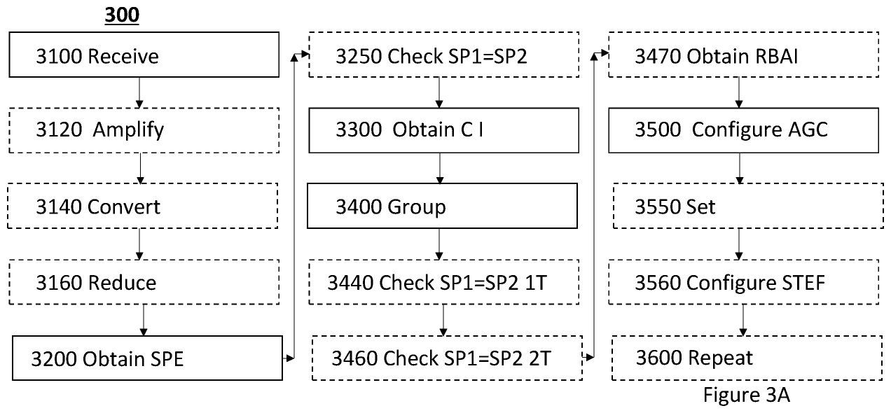

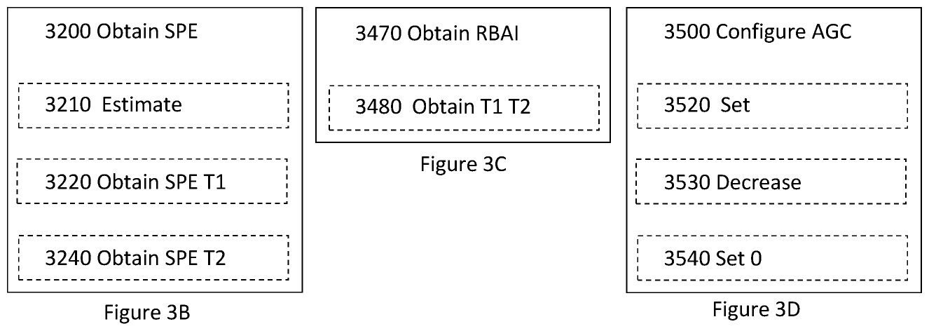

FIGS. 3A-3D illustrates actions/method steps implemented in a multi-antenna transmitter and receiver arrangement (MATARA) 300 according to some embodiments. The MATARA 300 comprises two or more antennas 301, 302, . . . , 316, two or more transceiver front ends 320, 321, . . . , 328 (each comprising one or two or more transceivers), and two or more automatic gain controllers, AGCs, 330, 331, . . . , 338. In some embodiments, the MATARA 300 is as described above in connection with FIGS. 1A-1D. Furthermore, the MATARA 300 is comprised or comprisable in a wireless device (WD) 397. The MATARA 300 is configured to receive 3100 a first plurality of radio signals comprising a first signal transmitted from a remote TNode. To this end, the MATARA 300 may be associated with (e.g., operatively connectable, or connected, to) a first receiving unit (e.g., first receiving circuitry, a first receiver, or the two or more antennas 301, 302, . . . , 316 and the two or more transceiver front ends 320, 321, . . . , 328, each comprising one or two or more transceivers). Furthermore, the MATARA 300 is configured to obtain 3200 a signal power estimate for each of the first plurality of radio signals (optionally including estimate 3210, obtain 3220, and obtain 3240 in a similar manner as described for steps 121, 122 and 124 above in connection with FIG. 1). To this end, the MATARA 300 may be associated with (e.g., operatively connectable, or connected, to) a first obtainment unit (e.g., first obtaining circuitry, a first obtainer, or the two or more automatic gain controllers (AGCs) 330, 331, . . . , 338). Moreover, the MATARA 300 is configured to obtain 3300 information about correlation between characteristics of the radio signals received by the transceivers. To this end, the MATARA 300 may be associated with (e.g., operatively connectable, or connected, to) a second obtainment unit (e.g., second obtaining circuitry, a second obtainer, a Zlatan, or the control unit 380). The MATARA 300 is configured to group 3400 transceivers together in groups of transceivers in accordance with the obtained information. To this end, the MATARA 300 may be associated with (e.g., operatively connectable, or connected, to) a second obtainment unit (e.g., second obtaining circuitry, a second obtainer, or the control unit 380). Furthermore, the MATARA 300 is configured to configure 3500 the AGCs in accordance with the obtained signal power estimates and in accordance with the groups of transceivers. To this end, the MATARA 300 may be associated with (e.g., operatively connectable, or connected, to) a second obtainment unit (e.g., second obtaining circuitry, a second obtainer, or the control unit 380). In some embodiments, the MATARA 300 is configured to amplify 3120 the received first plurality of radio signals. To this end, the MATARA 300 may be associated with (e.g., operatively connectable, or connected, to) a first set of amplifying units (e.g., a first set of amplifying circuitry or a set of variable gain amplifiers, VGAs). Furthermore, in some embodiments, the MATARA 300 is configured to convert 3140 the (first plurality of) amplified radio signals into (a first plurality of) digital radio signals. To this end, the MATARA 300 may be associated with (e.g., operatively connectable, or connected, to) a first set of converting units (e.g., a first set of converting circuitry or a set of analog-to-digital converters, ADCs). Moreover, in some embodiments, the MATARA 300 is configured to reduce 3160 the first plurality of digital radio signals to a second plurality of filtered digital radio signals. To this end, the MATARA 300 may be associated with (e.g., operatively connectable, or connected, to) a first reducing unit (e.g., reducing circuitry or one or more spatio-temporal filters, STEFs). In some embodiments, the MATARA 300 is configured to check 3250, for each of the first plurality of radio signals, if the signal power estimate at the second time instant is substantially the same as the signal power estimate at the first time instant (i.e., if the difference between the first and second signal power estimates is below a threshold amount, such as 0.1). To this end, the MATARA 300 may be associated with (e.g., operatively connectable, or connected, to) a first checking unit (e.g., first checking circuitry or the control unit 380). Furthermore, in some embodiments, the MATARA 300 is configured to check 3440 if the first and second signal power estimates associated with the first transceiver are substantially the same (i.e., the difference between the first and second signal power estimates is below a threshold amount, such as 0.1). To this end, the MATARA 300 may be associated with (e.g., operatively connectable, or connected, to) a second checking unit (e.g., second checking circuitry or the control unit 380). Moreover, in some embodiments, the MATARA 300 is configured to check 3460 if the first and second signal power estimates associated with the second transceiver are substantially the same (i.e., the difference between the first and second signal power estimates is below a threshold amount, such as 0.1). To this end, the MATARA 300 may be associated with (e.g., operatively connectable, or connected, to) a third checking unit (e.g., third checking circuitry or the control unit 380). In some embodiments, the MATARA 300 is configured to obtain 3470 resource block allocation information (associated with the first signal) from a subset of the first plurality of radio signals (optionally including obtain 3480 in a similar manner as described for steps 148 above in connection with FIG. 1). To this end, the MATARA 300 may be associated with (e.g., operatively connectable, or connected, to) a third obtainment unit (e.g., third obtaining circuitry, a third obtainer, the BB processor 340 or the control unit 380). Furthermore, in some embodiments, the MATARA 300 is configured to set 3550 the gain of the corresponding AGC to a first gain for the first time instant (or for a first time period associated with the first time instant) and to a second gain for the second time instant (or for a second time period associated with the second time instant). To this end, the MATARA 300 may be associated with (e.g., operatively connectable, or connected, to) a first setting unit (e.g., first setting circuitry, a first setter, the BB processor 340 or the control unit 380). Moreover, in some embodiments, the MATARA 300 is configured to configure 3560 the STEF or STEFs 360 (or filter coefficients thereof) in accordance with the configuring 3500 of the AGCs (optionally including set 3520, decrease 3530, and set to zero 3540 in a similar manner as described for steps 152, 153 and 154 above in connection with FIG. 1). To this end, the MATARA 300 may be associated with (e.g., operatively connectable, or connected, to) a first configuring unit (e.g., first configuring circuitry, a first configurer, the BB processor 340 or the control unit 380). In some embodiments, the MATARA 300 is configured to repeat 3600 the steps 110, 120, 130, 140, 150 and optionally one or more of the steps of 112, 114, 116, 125, 144, 146, 147, 155, 156, 121, 122, 124, 148, 152, 153 and 154. To this end, the MATARA 300 may be associated with (e.g., operatively connectable, or connected, to) a first repetition unit (e.g., first repeating circuitry, a first repeater, the BB processor 340 or the control unit 380).

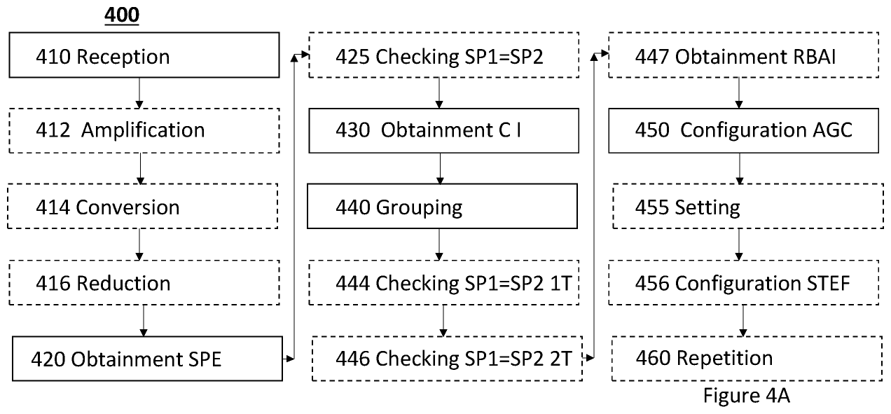

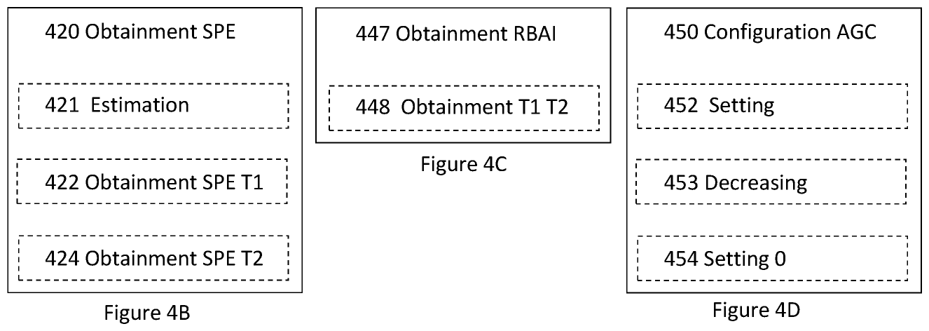

FIGS. 4A-4D illustrates actions/method steps caused by control unit 380 for a multi-antenna transmitter and receiver arrangement (MATARA) 300 according to some embodiments. The MATARA 300 comprises two or more antennas 301, 302, . . . , 316, two or more transceiver front ends 320, 321, . . . , 328 (each comprising one or two or more transceivers), and two or more automatic gain controllers, AGCs, 330, 331, . . . , 338. In some embodiments, the MATARA 300 is as described above in connection with FIGS. 1A-1D. Furthermore, the MATARA 300 is comprised or comprisable in a wireless device (WD) 397. The control unit 380 is configured to cause reception 410 of a first plurality of radio signals comprising a first signal transmitted from a remote TNode. To this end, the control unit 380 may be associated with (e.g., operatively connectable, or connected, to) a first receiving unit (e.g., first receiving circuitry, a first receiver, or the two or more antennas 301, 302, . . . , 316 and the two or more transceiver front ends 320, 321, . . . , 328, each comprising one or two or more transceivers). Furthermore, the control unit 380 is configured to cause obtainment 420 of a signal power estimate for each of the first plurality of radio signals (optionally including estimate 3210, obtain 3220, and obtain 3240 in a similar manner as described for steps 121, 122 and 124 above in connection with FIG. 1). To this end, the control unit 380 may be associated with (e.g., operatively connectable, or connected, to) a first obtainment unit (e.g., first obtaining circuitry, a first obtainer, an Ibra, or the two or more automatic gain controllers, AGCs, 330, 331, . . . , 338). Moreover, the control unit 380 is configured to cause obtainment 430 of information about correlation between characteristics of the radio signals received by the transceivers. To this end, the control unit 380 may be associated with (e.g., operatively connectable, or connected, to) a second obtainment unit (e.g., second obtaining circuitry, a second obtainer). The control unit 380 is configured to cause grouping 440 of transceivers together in groups of transceivers in accordance with the obtained information. To this end, the control unit 380 may be associated with (e.g., operatively connectable, or connected, to) a second obtainment unit (e.g., second obtaining circuitry, or a second obtainer). Furthermore, the control unit 380 is configured to cause configuration 450 of the AGCs in accordance with the obtained signal power estimates and in accordance with the groups of transceivers. To this end, the control unit 380 may be associated with (e.g., operatively connectable, or connected, to) a second obtainment unit (e.g., second obtaining circuitry, or a second obtainer). In some embodiments, the control unit 380 is configured to cause amplification 412 of the received first plurality of radio signals. To this end, the control unit 380 may be associated with (e.g., operatively connectable, or connected, to) a first set of amplifying units (e.g., a first set of amplifying circuitry or a set of variable gain amplifiers, VGAs). Furthermore, in some embodiments, the control unit 380 is configured to cause conversion 414 of the (first plurality of) amplified radio signals into (a first plurality of) digital radio signals. To this end, the control unit 380 may be associated with (e.g., operatively connectable, or connected, to) a first set of converting units (e.g., a first set of converting circuitry or a set of analog-to-digital converters, ADCs). Moreover, in some embodiments, the control unit 380 is configured to cause reduction 416 of the first plurality of digital radio signals to a second plurality of filtered digital radio signals. To this end, the control unit 380 may be associated with (e.g., operatively connectable, or connected, to) a first reducing unit (e.g., reducing circuitry or one or more spatio-temporal filters, STEFs). In some embodiments, the control unit 380 is configured to cause checking 425, for each of the first plurality of radio signals, of if the signal power estimate at the second time instant is substantially the same as the signal power estimate at the first time instant (i.e., if the difference between the first and second signal power estimates is below a threshold amount, such as 0.1). To this end, the control unit 380 may be associated with (e.g., operatively connectable, or connected, to) a first checking unit (e.g., first checking circuitry or a first checker). Furthermore, in some embodiments, the control unit 380 is configured to cause checking 444 of if the first and second signal power estimates associated with the first transceiver are substantially the same (i.e., the difference between the first and second signal power estimates is below a threshold amount, such as 0.1). To this end, the control unit 380 may be associated with (e.g., operatively connectable, or connected, to) a second checking unit (e.g., second checking circuitry or a second checker). Moreover, in some embodiments, the control unit 380 is configured to cause checking 446 of if the first and second signal power estimates associated with the second transceiver are substantially the same (i.e., the difference between the first and second signal power estimates is below a threshold amount, such as 0.1). To this end, the control unit 380 may be associated with (e.g., operatively connectable, or connected, to) a third checking unit (e.g., third checking circuitry or a third checker). In some embodiments, the control unit 380 is configured to cause obtainment 447 of resource block allocation information from a subset of the first plurality of radio signals (optionally including obtainment 448 in a similar manner as described for steps 148 above in connection with FIG. 1). To this end, the control unit 380 may be associated with (e.g., operatively connectable, or connected, to) a third obtainment unit (e.g., third obtaining circuitry, a third obtainer, or the BB processor 340). Furthermore, in some embodiments, the control unit 380 is configured to cause setting 455 of the gain of the corresponding AGC to a first gain for the first time instant (or for a first time period associated with the first time instant) and to a second gain for the second time instant (or for a second time period associated with the second time instant). To this end, the control unit 380 may be associated with (e.g., operatively connectable, or connected, to) a first setting unit (e.g., first setting circuitry, a first setter, or the BB processor 340). Moreover, in some embodiments, the control unit 380 is configured to cause configuration 456 of the STEF or STEFs 360 (or filter coefficients thereof) in accordance with the configuring 450 of the AGCs (optionally including setting 452, decreasing 453, and setting to zero 454 in a similar manner as described for steps 152, 153 and 154 above in connection with FIG. 1). To this end, the control unit 380 may be associated with (e.g., operatively connectable, or connected, to) a first configuring unit (e.g., first configuring circuitry, a first configurer, or the BB processor 340). In some embodiments, the control unit 380 is configured to cause repetition 460 of the steps 110, 120, 130, 140, 150 and optionally of one or more of the steps of 112, 114, 116, 125, 144, 146, 147, 155, 156, 121, 122, 124, 148, 152, 153 and 154. To this end, the control unit 380 may be associated with (e.g., operatively connectable, or connected, to) a first repetition unit (e.g., first repeating circuitry, a first repeater, or the BB processor 340).

FIG. 5 illustrates a wireless device (WD) 397 according to some embodiments. The WD 397 comprises a multi-antenna transmitter and receiver arrangement (MATARA) 300 (e.g., as described above in connection with FIGS. 1-4C). Furthermore, the WD 397 comprises a baseband (BB) processor 340 (e.g., as described above in connection with FIGS. 1-4° C.). In some embodiments, the MATARA 300 is connected or connectable to the BB processor 340. Alternatively, the MATARA 300 comprises the BB processor 340. The MATARA 300 comprises two or more antennas 301, 302, . . . , 316. Furthermore, the MATARA 300 comprises one or two or more transceiver front ends 320, 321, . . . , 328. Each transceiver front end 320, 321, . . . , 328 comprises one or two or more transceivers. Furthermore, each of the transceiver front end 320, 321, . . . , 328 is connected to one or two respective antennas 301, 302, . . . , 316. Moreover, the MATARA 300 comprises two or more automatic gain controllers (AGCs) 330, 331, . . . , 338. The MATARA 300 comprises two or more variable gain amplifiers (VGAs) 350, 351, . . . , 358. Each of the two or more VGAs 350, 351, . . . , 358 is connected to a respective transceiver front end 320, 321, . . . , 328. Furthermore, each of the two or VGAs 350, 351, . . . , 358 is connected to a respective AGC 330, 331, . . . , 338. Moreover, the MATARA 300 comprises two or more analog-to-digital converters (ADCs) 370, 371, . . . , 378. Each of the two or more ADCs 370, 371, . . . , 378 is connected to a respective VGA 350, 351, . . . , 358 (for receiving an analog input signal), and to a respective AGC 330, 331, . . . , 338. In some embodiments, the MATARA 300 comprises a spatio-temporal filter (STEF) 360. In these embodiments, the ADCs 370, 371, . . . , 378 are connected to the STEF 360, and the STEF 360 is connected to the BB processor 340. Alternatively, the ADCs 370, 371, . . . , 378 are directly connected to the BB processor 340. Moreover, in some embodiments, the MATARA 300 comprises a control unit 380. The control unit 380 may be comprised in one or more chips 912. The one or more chips 912 may comprise the control unit 380 and optionally one or more of the BB processor 340, the one or more STEFs 360, the two or more ADCs 370, 371, . . . , 378, and the two or more AGCs 330, 331, 338. In some embodiments, the one or more chips 912 comprises the BB processor 340 and the BB processor 340 comprises the control unit 380. Furthermore, in some embodiments, the one or more chips 912 is a digital intermediate frequency (Dig-IF) chip which comprises the two or more ADCs 370, 371, . . . , 378, the one or more STEFs 360, the two or more AGCs 330, 331, 338 and the control unit 380. The control unit 380 is connected to the BB processor 340 (for receiving information and/or control data). Furthermore, the control unit is connected to each of the AGCs 330, 331, . . . , 338 and able to or configured to receive information, such as signal power estimates (SPEs), from each of the AGCs 330, 331, . . . , 338 and able/configured to control each of the AGCs 330, 331, . . . , 338. The WD may be configured to communicate with (e.g., send and receive signals, such as radio signals, to/from) one or more remote transceiver nodes (TNodes) 398, 399. Furthermore, in some embodiments, the BB processor 340 comprises a channel estimation/combining unit 342. The channel estimation/combining unit 342 is configured to combine/reduce the second plurality of filtered digital radio signals to a third plurality of filtered digital radio signals. In some embodiments, the second plurality is larger than the third plurality (i.e., the number of the second plurality of filtered digital radio signals is larger than the number of the third plurality of filtered digital radio signals).

Furthermore, the channel estimation/combining unit 342 may be (directly) connected to the STEF 360. In some embodiments, the channel estimation/combining unit 342 is utilized to determine the allocated resource blocks (sub-carriers) or the number thereof.

In some embodiments, the first plurality of radio signals, the first plurality of amplified radio signals, and the first plurality of digital radio signals are equal in number.

### List of Examples

Example 1. A method (100) for a multi-antenna transmitter and receiver arrangement, MATARA, (300), the MATARA (300) comprising two or more antennas (301, 302, . . . , 316), two or more transceiver front ends (320, 321, . . . , 328) each comprising two or more transceivers, and two or more automatic gain controllers, AGCs, (330, 331, . . . , 338) and wherein the MATARA (300) is comprisable in a wireless device, WD, (397), the method comprising:
receiving (110) a first plurality of radio signals comprising a first signal transmitted from a remote TNode (398, 399);
obtaining (120) a signal power estimate for each of the first plurality of radio signals;
obtaining (130) information about correlation between characteristics of the radio signals received by the transceivers;
grouping (140) transceivers together in groups of transceivers in accordance with the obtained information; and
configuring (150) the AGCs in accordance with the obtained signal power estimates and in accordance with the groups of transceivers.
Example 2. The method of example 1, wherein each group of transceivers comprises a first transceiver connected to a vertically polarized antenna and a second transceiver connected to a horizontally polarized antenna, wherein each of the first and second transceivers is associated with one of the obtained signal power estimates, and wherein each AGC is configured in accordance with the obtained signal power estimates associated with the first and second transceivers.
Example 3. The method of example 1, wherein each group of transceivers comprises a first transceiver connected to a vertically polarized antenna and a second transceiver connected to a horizontally polarized antenna, wherein obtaining (120) a signal power estimate for each of the first plurality of radio signals comprises obtaining (122) a first signal power estimate for each of the first plurality of radio signals at a first time instant, and obtaining (124) a second signal power estimate for each of the first plurality of radio signals at a second time instant, and wherein the method further comprises:
checking (144) if the first and second signal power estimates associated with the first transceiver are substantially the same;
checking (146) if the first and second signal power estimates associated with the second transceiver are substantially the same; and
wherein configuring (150) the AGCs comprises setting (152) the AGCs having substantially the same first and second signal power estimates for both the first and second transceivers to be inverse proportional to the signal power estimates associated with the first transceiver and/or the second transceiver.
Example 4. The method of example 1, wherein each group of transceivers comprises a transceiver for in-phase data and a transceiver for corresponding quadrature data, and wherein a signal power estimate is obtained only for one of the transceiver for in-phase data and the transceiver for corresponding quadrature data and wherein the AGC corresponding to the transceiver for in-phase data and the transceiver for corresponding quadrature data is configured in accordance with the obtained signal power estimate.
Example 5. The method of example 1, wherein configuring (150) the AGCs comprises:
for each radio signal of the first plurality of radio signals having a signal power estimate lower than a signal power threshold, decreasing the gain of the AGC, such as decreasing (153) the gain of the AGC significantly, or setting (154) the gain of the AGC to zero.
Example 6. The method of any of examples 1-5, wherein the MATARA (300) further comprises a baseband, BB, processor (340), and wherein the method further comprises:
obtaining (147), by the BB processor, resource block allocation information associated with the first signal from a subset of the first plurality of radio signals; and
wherein configuring (150) the AGCs is performed in accordance with the obtained resource block allocation information.
Example 7. The method of example 6, wherein the MATARA (300) further comprises two or more variable gain amplifiers, VGAs, (350, 351, . . . , 358), and two or more analog-to-digital converters, ADCs, (370, 371, . . . , 378), wherein each VGA is connected to a respective ADC, and wherein the method further comprises:
amplifying (112), by the VGAs, the received first plurality of radio signals; and
converting (114), by the ADCs, the amplified radio signals into digital radio signals.
Example 8. The method of example 7, wherein the MATARA (300) further comprises a spatio-temporal filter, STEF, (360), wherein the ADCs are connected to the STEF, wherein the STEF is connected to the BB processor (340) and wherein the method further comprises:
reducing (116), by the STEF, the first plurality of digital radio signals to a second plurality of filtered digital radio signals, and
wherein the second plurality is smaller than the first plurality.
Example 9. The method of example 8, wherein the MATARA (300) further comprises a control unit (380), and wherein the method further comprises:
configuring (156), by the control unit, the STEF (360) in accordance with the configuring (150) of the AGCs.
Example 10. The method of any of examples 6-9, wherein obtaining (120) a signal power estimate for each of the first plurality of radio signals comprises obtaining (122) a signal power estimate for each of the first plurality of radio signals at a first time instant, and obtaining (124) a signal power estimate for each of the first plurality of radio signals at a second time instant, and wherein obtaining (147) resource block allocation information comprises obtaining (148) resource block allocation information at a first time instant and at a second time instant, the method further comprising:
checking (125), for each of the first plurality of radio signals, if the signal power estimate at the second time instant is substantially the same as the signal power estimate at the first time instant;
for each of the first plurality of radio signals having the signal power estimate at the second time instant substantially the same as the signal power estimate at the first time instant, checking (149) the resource block allocation information to find out if the number of resource blocks allocated at the first time instant is larger than the number of resource blocks allocated at a second time instant; and
for each of the first plurality of radio signals having the signal power estimate at the second time instant substantially the same as the signal power estimate at the first time instant and the number of resource blocks allocated at the first time instant larger than the number of resource blocks allocated at a second time instant, setting (155) the gain of the corresponding AGC to a first gain for the first time instant and to a second gain for the second time instant, wherein the second gain is smaller than the first gain.
Example 11. The method of any of examples 1-10, wherein obtaining (120) a signal power estimate comprises estimating (121) the signal power in accordance with:
an actual signal power estimate, such as a received signal strength indicator, RSSI;
a sum of absolute values, such as a sum of absolute values of in-phase data and quadrature data;
a number of saturated ADC samples and optionally a look up table; or
a number of non-saturated ADC samples and optionally a look up table.
Example 12. A computer program product comprising a non-transitory computer readable medium (200), having stored thereon a computer program comprising program instructions, the computer program being loadable into a data processing unit (220) and configured to cause execution of the method of any of examples 1-11 when the computer program is run by the data processing unit (220).
Example 13. A multi-antenna transmitter and receiver arrangement, MATARA, (300), the MATARA (300) comprising two or more antennas (301, 302, . . . , 316), two or more transceivers (320, 321, . . . , 328), and two or more automatic gain controllers, AGCs, (330, 331, . . . , 338) and wherein the MATARA (300) is comprisable in a wireless device, WD, (397), the MATARA (300) configured to:
receive (3100) a first plurality of radio signals comprising a first signal transmitted from a remote TNode;
obtain (3200) a signal power estimate for each of the first plurality of radio signals;
obtain (3300) information about correlation between characteristics of the radio signals received by the transceivers;
group (3400) transceivers together in groups of transceivers in accordance with the obtained information; and
configure (3500) the AGCs in accordance with the obtained signal power estimates and in accordance with the groups of transceivers.
Example 14. A control unit (380) for a multi-antenna transmitter and receiver arrangement, MATARA, (300), the MATARA (300) comprising two or more antennas (301, 302, . . . , 316), two or more transceivers (320, 321, . . . , 328), and two or more automatic gain controllers, AGCs, (330, 331, . . . , 338) and wherein the MATARA (300) is comprisable in a wireless device, WD, (397), the control unit configured to cause:
reception (410) of a first plurality of radio signals comprising a first signal transmitted from a remote TNode;
obtainment (420) of a signal power estimate for each of the first plurality of radio signals;
obtainment (430) of information about correlation between characteristics of the radio signals received by the transceivers;
grouping (440) of transceivers together in groups of transceivers in accordance with the obtained information; and
configuration (450) of the AGCs in accordance with the obtained signal power estimates and in accordance with the groups of transceivers.
Example 15. A wireless device, WD, (397) comprising the MATARA (300) of example 13 and/or the control unit (380) of example 14.
Example 16. A chip (912) comprising the control unit (380) of example 14.

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some actions/method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

### LIST OF SOME ACRONYMS AND ABBREVIATIONS THAT MAY APPEAR IN THE DESCRIPTION

3GPP—3rd Generation Partnership Project
5G—fifth generation
5G—NR (5G—New Radio) is a new RAT developed by 3GPP for the 5G mobile network
ADC—analog-to-digital converter
AGC—automatic gain controller
BB—baseband
BF—beamforming
BW—bandwidth
CSI-RS—channel state information reference signal
CU—control unit
DAC—digital-to-analog converter
DCI—downlink control information
DL-PRS—downlink positioning reference signal
DM-RS—demodulation reference signal
FR 1—Frequency Range 1
FR1.5—Frequency Range 1.5
FR2—Frequency Range 2
Fe—Front end
FWA—Fixed Wireless Access
GNSS—Global navigation satellite system
GPS—Global Positioning System
IF—intermediate frequency
I/O—input/output
L1—Layer 1
LNA—linear Noise Amplifier
LO—Local Oscillator
LOS—Line of Sight
LTE—Long-Term Evolution
MAC—Medium Access Control
MATARA—multi-antenna transmitter and receiver arrangement
MIMO—multiple input, multiple output
mmW—millimeter wave
NAS—Non-access Stratum
nLoS—non-Line of Sight
OFDM—orthogonal frequency-division multiplexing
PA—power amplifier
PBCH—Physical Broadcast Channel
PCB—printed circuit board
PCell—primary cell
PDCCH—physical downlink control channel
PDSCH—physical downlink shared channel
PHY—Physical Layer
PLL—phase locked loop
PSCell—primary secondary cell
PSS—primary synchronization signal
PT-RS—Phase Tracking Reference signal
PUCCH—physical uplink control channel
PUSCH—physical uplink shared channel
QCL—quasi co-located
QoS—quality of service
RAT—radio access technology
RRC—radio resource control
RSRP—Reference Signal Received Power
RSRQ—Reference Signal Received Quality
RSSI—Received Signal Strength Indicator
SCell—Secondary Cell
SNR—Signal-to-noise ratio
SSB—Synchronization Signal Block
SRS—sounding reference signal
SSS—secondary synchronization signal
STEF—spatio-temporal filter
STF—spatial transmission filter
TNode—transceiver node
VGA—variable gain amplifier
WD—wireless device

1. A method for a multi-antenna transmitter and receiver arrangement, (MATRA), the MATARA comprising:
two or more antennas;
two or more transceiver front ends each transceiver front end comprising two or more transceivers;
a baseband (BB) processor; and
two or more automatic gain controllers (AGCs) and wherein the MATARA is comprisable in a wireless device (WD) the method comprising:
receiving a first plurality of radio signals comprising a first signal transmitted from a remote transceiver node (TNode) obtaining a signal power estimate for each of the first plurality of radio signals;
obtaining information about correlation between characteristics of the first plurality of radio signals received by the transceivers;
grouping transceivers together in groups of transceivers in accordance with the obtained information;
obtaining, by the BB processor, resource block allocation information associated with the first signal from a subset of the first plurality of radio signals; and
configuring the AGCs in accordance with the obtained signal power estimates, in accordance with the obtained resource block allocation information, and/or in accordance with the groups of transceivers.

2. The method of claim 1, wherein each group of transceivers comprises a transceiver for in-phase data and a transceiver for corresponding quadrature data, and wherein a signal power estimate is obtained only for one of the transceiver for in-phase data and the transceiver for corresponding quadrature data and wherein the AGC corresponding to the transceiver for in-phase data and the transceiver for corresponding quadrature data is configured in accordance with the obtained signal power estimate.

3. The method of claim 1, wherein each group of transceivers comprises a first transceiver connected to a vertically polarized antenna and a second transceiver connected to a horizontally polarized antenna, wherein each of the first and second transceivers is associated with one of the obtained signal power estimates, and wherein each AGC is configured in accordance with the obtained signal power estimates associated with the first and second transceivers.

4. The method of claim 1, wherein each group of transceivers comprises a first transceiver connected to a vertically polarized antenna and a second transceiver connected to a horizontally polarized antenna, wherein obtaining a signal power estimate for each of the first plurality of radio signals comprises obtaining a first signal power estimate for each of the first plurality of radio signals at a first time instant, and obtaining a second signal power estimate for each of the first plurality of radio signals at a second time instant, and wherein the method further comprises:
checking if the first and second signal power estimates associated with the first transceiver are substantially the same;
checking if the first and second signal power estimates associated with the second transceiver are substantially the same; and
wherein configuring the AGCs comprises setting the AGCs having substantially the same first and second signal power estimates for both the first and second transceivers to be inverse proportional to the signal power estimates associated with the first transceiver and/or the second transceiver.

5. The method of claim 1, wherein configuring the AGCs comprises:
for each radio signal of the first plurality of radio signals having a signal power estimate lower than a signal power threshold, decreasing the gain of the AGC.

6. The method of claim 1, wherein decreasing the gain of the AGC comprises decreasing the gain of the AGC significantly.

7. The method of claim 6, wherein the MATARA further comprises two or more variable gain amplifiers (VGAs) and two or more analog-to-digital converters (ADCs) wherein each VGA is connected to a respective ADC, and wherein the method further comprises:
amplifying, by the VGAs, the received first plurality of radio signals; and
converting, by the ADCs, the first plurality of amplified radio signals into a first plurality of digital radio signals.

8. The method of claim 7, wherein the MATARA further comprises a spatio-temporal filter (STEF) wherein the ADCs are connected to the STEF, wherein the STEF is connected to the BB processor and wherein the method further comprises:
reducing by the STEF, the first plurality of digital radio signals to a second plurality of filtered digital radio signals, and wherein the second plurality is smaller than the first plurality.

9. The method of claim 8, wherein the MATARA further comprises a control unit and wherein the method further comprises:
configuring by the control unit, the STEF in accordance with the configuring of the AGCs.

10. The method of claim 6, wherein obtaining a signal power estimate for each of the first plurality of radio signals comprises obtaining a signal power estimate for each of the first plurality of radio signals at a first time instant, and obtaining a signal power estimate for each of the first plurality of radio signals at a second time instant, and wherein obtaining resource block allocation information comprises obtaining resource block allocation information at a first time instant and at a second time instant, the method further comprising:
checking, for each of the first plurality of radio signals, if the signal power estimate at the second time instant is substantially the same as the signal power estimate at the first time instant;
for each of the first plurality of radio signals having the signal power estimate at the second time instant substantially the same as the signal power estimate at the first time instant, checking the resource block allocation information to find out if the number of resource blocks allocated at the first time instant is larger than the number of resource blocks allocated at a second time instant; and
for each of the first plurality of radio signals having the signal power estimate at the second time instant substantially the same as the signal power estimate at the first time instant and the number of resource blocks allocated at the first time instant larger than the number of resource blocks allocated at a second time instant, setting the gain of the corresponding AGC to a first gain for the first time instant and to a second gain for the second time instant, wherein the second gain is smaller than the first gain.

11. The method of claim 1, wherein obtaining a signal power estimate comprises estimating the signal power in accordance with an actual signal power estimate.

12. The method of claim 11, wherein the actual signal power estimate is a received signal strength indicator (RSSI).

13. The method of claim 1 wherein obtaining a signal power estimate comprises estimating the signal power in accordance with a sum of absolute values.

14. The method of claim 13, wherein the sum of absolute values is a sum of absolute values of in-phase data and quadrature data.

15. The method of claim wherein obtaining a signal power estimate comprises estimating the signal power in accordance with a number of saturated ADC samples.

16. The method of claim 15, wherein obtaining a signal power estimate comprises estimating the signal power in accordance with a first look up table.

17. The method of claim 1 wherein obtaining a signal power estimate comprises estimating the signal power in accordance with a number of non-saturated ADC samples.

18. The method of claim 17, wherein obtaining a signal power estimate comprises estimating the signal power in accordance with a second look up table.

19-22. (canceled)

23. A multi-antenna transmitter and receiver arrangement (MATARA) the MATARA comprising two or more antennas;
two or more transceiver front ends each comprising two or more transceivers; a baseband (BB); and two or more automatic gain controllers (AGCs) and wherein the MATARA is comprisable in a wireless device (WD) the MATARA configured to:
receive a first plurality of radio signals comprising a first signal transmitted from a remote transceiver node (TNode);
obtain a signal power estimate for each of the first plurality of radio signals;
obtain information about correlation between characteristics of the first plurality of radio signals received by the transceivers;
group transceivers together in groups of transceivers in accordance with the obtained information;
obtain resource block allocation information from a subset of the first plurality of radio signals; and
configure the AGCs in accordance with the obtained signal power estimates, in accordance with the obtained resource block allocation information, and in accordance with the groups of transceivers.

24. A control unit for a multi-antenna transmitter and receiver arrangement (MATARA) the MATARA comprising two or more antennas two or more transceiver front ends each transceiver from end comprising two or more transceivers; a baseband (BB) processor; and two or more automatic gain controllers, AGCs, and wherein the MATARA is comprisable in a wireless device (WD) the control unit configured to cause:
reception of a first plurality of radio signals comprising a first signal transmitted from a remote (TNode);
obtainment of a signal power estimate for each of the first plurality of radio signals;
obtainment of information about correlation between characteristics of the first plurality of radio signals received by the transceivers;
grouping of transceivers together in groups of transceivers in accordance with the obtained information;
obtainment of resource block allocation information from a subset of the first plurality of radio signals; and
configuration of the AGCs in accordance with the obtained signal power estimates, in accordance with the obtained resource block allocation information, and in accordance with the groups of transceivers.

25-26. (canceled)
